(19) United States
(12) Patent Application Publication
(10) Pub. No.: US 2014/0324908 A1
(43) Pub. Date: Oct. 30, 2014

(54) METHOD AND SYSTEM FOR INCREASING ACCURACY AND COMPLETENESS OF ACQUIRED DATA

(71) Applicant: GENERAL ELECTRIC COMPANY, Schenectady, NY (US)

(72) Inventors: Michael Evans Graham, Slingerlands, NY (US); Andrew Walter Crapo, Scotia, NY (US); Abha Moitra, Scotia, NY (US); Gerald Bowden Wise, Clifton Park, NY (US); Steven Matt Gustafson, Niskayuna, NY (US); Victor Manuel Perez-Zarate, Halfmoon, NY (US); Luis Babaji Ng Tari, Schenectady, NY (US)

(73) Assignee: GENERAL ELECTRIC COMPANY, Schenectady, NY (US)

(21) Appl. No.: 13/872,868

(22) Filed: Apr. 29, 2013

(51) Int. Cl. G06F 17/30

(52) U.S. Cl. CPC G06F 17/30684
USPC 707/776

(57) ABSTRACT

The present disclosure relates to the use of both semantic analysis and statistical text mining to process data records, improving the completeness and accuracy of records so processed. By way of example, a data record may be iteratively processed by text mining using seeds derived from a semantic template and by validating the results based on semantic reasoning based on the semantic template.

### BACKGROUND

The subject matter disclosed herein relates to the accuracy and completeness of data records drawn from historical and current sources.

Data may be collected and stored for numerous industrial, commercial, and personal applications. For example, routine transactions may generate various types of data or new data points in an ongoing sequence. Such data may in turn be reviewed, evaluated, and used in various decision making processes, such as maintenance or repair tracking or planning in a building or vehicle context, budgetary planning, financial forecasting, or regulatory compliance and planning.

Inaccurate and incomplete data, however may result in errors in these various processes or, more generally, may result in inaccurate decisions being drawn, improper actions being taken, or proper action not being taken. Such data problems may result from various sources, such as a set of data being incomplete, data points being recorded inaccurately, or data points being improperly characterized or categorized. These types of errors may arise in historical data or data being collected currently or contemporaneously and may arise in both fixed choice and free text data collection methodologies.

### BRIEF DESCRIPTION

In one embodiment, a computer-implemented method is provided for processing data. The method includes the acts of accessing a data record and performing a text mining operation on the data record using seeds derived from a semantic template encompassing the data record. One or more fields of a data instance are populated using data elements derived from the analysis of the data record by the text mining operation. The data instance is based on the semantic template. The data instance is then updated based on semantic rules defined by the semantic template. The seeds are updated and the steps of: performing the text mining operation, populating one or more fields of the data instance, and updating the data instance based on semantic rules to generate a final data instance are iterated.

In a further embodiment, a data processing system is provided. The data processing system comprises a memory storing one or more routines; and a processing component configured to communicate with the controller and to execute the one or more routines stored in the memory. The one or more routines, when executed by the processing component, cause acts to be performed comprising: accessing a data record related to a transaction; accessing a set of seeds derived from a semantic template that describes the transaction; text mining the data record using the set of seeds; populating one or more fields of a semantic instance using data elements identified in the data record by text mining, wherein the data instance is based on the semantic template and wherein the one or more fields are populated based upon probabilities generated by the text mining; and analyzing the data instance based on one or more semantic rules associated with the semantic instance to validate the populated one or more fields of the semantic instance.

In an additional embodiment, one or more non-transitory computer-readable media are provided encoding one or more processor-executable routines. The one or more routines, when executed by a processor, cause acts to be performed comprising: accessing a data record related to a transaction; accessing a semantic template derived from a plurality of representative transactions that described the transaction; and generating a data instance corresponding to the data record by iteratively: performing statistical text mining of the data record using seeds derived from the semantic template; and analyzing the data instance using one or more semantic rules derived from the semantic template.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an electronic devise suitable for processing data, in accordance with aspects of the present disclosure;

FIG. 2 is a flowchart depicting control logic for generating a semantic template, in accordance with aspects of the present disclosure;

FIG. 3 is a flowchart depicting control logic for generating and processing data instances, in accordance with aspects of the present disclosure;

FIG. 4 is a sample of a semantic template, in accordance with aspects of the present disclosure;

FIG. 5 depicts a sample of n-tuples derived from an example of a semantic template, in accordance with aspects of the present disclosure;

FIG. 6 depicts a sample set of unstructured date, in accordance with aspects of the present disclosure;

FIG. 7 depicts an initial instance, in accordance with aspects of the present disclosure;

FIG. 8 depicts a corrected instance after review based on semantic rules, in accordance with aspects of the present disclosure;

FIG. 9 depicts a subsequent set of n-tuples based on the present instance iteration, in accordance with aspects of the present disclosure;

FIG. 10 depicts an updated instance after a second round of text mining, in accordance with aspects of the present disclosure; and

FIG. 11 depicts an updated instance within the context of a semantic template, in accordance with aspects of the present disclosure.

### DETAILED DESCRIPTION

Inaccurate and incomplete data can result in errors in the conclusions drawn from that data. That is, poor data quality can result in poor decision making, whether in an automated context (where a computer or other machine is provided the data and takes a corresponding action) or a human actor context. Such inaccurate and incomplete data may be present in data collected by “fixed choice” mechanisms (e.g., “check the box”) or “free text” data entry where a user types or writes a free form entry or record. However, as will be appreciated, “free text” data entry can introduce much more variability and uncertainty than data entry using fixed fields or options. As discussed herein, aspects of the present approach would drive the usability of free text fields to approach that of fields filled in by drop-down or radio box methods, and would facilitate and improve subsequent decision-making, automated or otherwise. Likewise, inaccurate and incomplete data may be present in both historical data contexts, where data may be collected or translated, from paper or other media, as well as in contemporaneous or real-time data collection. Aspects of the present approach may be used to improve the archived or existing data records as well as to facilitate or improve contemporaneous data collection. While certain examples and discussions within the present disclosure may relate to the processing of free text data fields for the reasons noted above, it should also be appreciated that the present approaches may also be used to improve the quality and accuracy of data acquired in non-free text contexts, such as where the data entry options are limited to specific values or choices. For example, the use of semantic templates, as discussed herein, may also be used to merge data sources that are not free text to improve the quality of data and data collection in these contexts as well.

The presently disclosed approaches relate to cleaning and controlling the accuracy of electronic data surrounding transactions (e.g., business transactions) or other similarly structured events. In particular, as discussed herein, the structure of the events is captured as semantic model templates, and instances of these models are created from the data. The content of fields with missing entries can be highlighted for acquisition or entry of the missing data. The content of fields with questionable or ambiguous data may be flagged for review and/or more suitable contents for the fields can be suggested. The electronic data to be processed can have been acquired at different times, i.e., may have varied temporality corresponding to archived events, historical events, finalized and completed current events, or currently occurring events with some components yet to happen in the future. For cleaning and accuracy control of historical data, the approaches discussed herein may be exercised periodically as additional new data becomes available, more extensive semantic templates are generated, or improved algorithms become available. For data arriving in real time, such as by conversation or simultaneous data entry, repeated application of the approach creates a converging semantic solution that can be used immediately for reasoning or classification purposes.

In addition, in one implementation the present approach addresses the generally low quality of data entered by humans in free text data input situations, such as may be found in customer service requests, for example. One instantiation of this approach would suggest wording improvements and sentence structure changes to people entering data into an otherwise free text field. This results in normalized data structures that flow smoothly into the event model discussed herein.

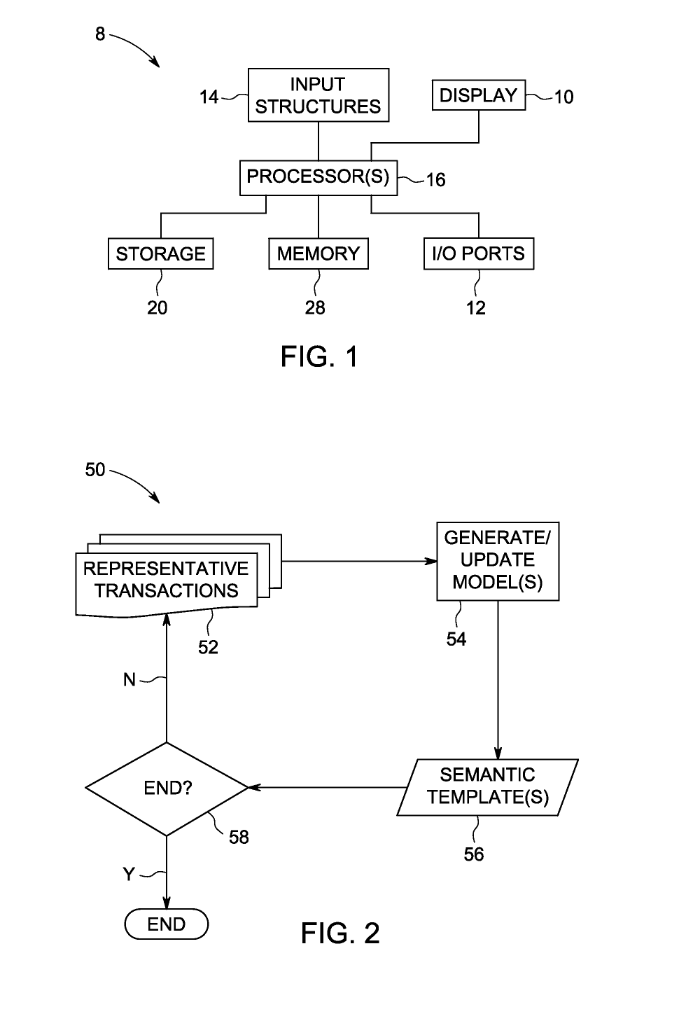

With the foregoing in mind, a general description is provided below of suitable electronic devices that may be used in the implementation of the present approaches to improve the accuracy or completeness of acquired data. In particular, FIG. 1 is a block diagram depicting various components that may be present in an electronic device (e.g., a general- or special-purpose computer system) suitable for executing routines for improving data completeness or accuracy as discussed herein.

As will be appreciated, the various functional blocks shown in FIG. 1 may comprise hardware elements (including circuitry), software elements (including computer code stored on a computer-readable medium), or a combination of both hardware and software elements. It should further be noted that FIG. 1 is merely one example of a system capable of implementing the present approaches and merely illustrates the types of components that may be present in a suitable electronic device 8. For example, in the presently illustrated embodiment, such components may include: a display 10 for displaying data or processed data as discussed herein; I/O ports 12 suitable for receiving data for processing or routines for execution and/or for exporting processed data; input structures 14 for receiving data or command inputs or entered data; one or more special- or general-purpose processors 16 for executing routines or control logic as discussed herein and/or for processing data as discussed herein; a memory device 28 for storing data or routines for execution by the processor 16; and a non-volatile storage 20 for providing long-term storage of data or routines.

With the foregoing discussion of suitable systems in mind, the present disclosure relates to the generation and use of a set of semantic models (i.e., templates) that describe a typical or generic instance of an event and encompass the various possible data that may be entered with respect to the event. For example, in one implementation, to construct a representation of a past, a present, or a future event an iterative solution may be employed that begins with the creation of a set of semantic models (templates) describing a comprehensive instance of an generalized event and all the available data describing that event. As used herein, the templates are semantic models describing the events (e.g., transactions) to which the data refers.

This process is depicted graphically by the flowchart 50 of FIG. 2. In this example, a set of representative transactions 52, such as customer inquiries, repair records, and so forth, is provided. Analysis of the representative transactions 52 may be used to generate (block 54) one or more semantic templates 56 (e.g., semantic models) that describe the event or events represented by the transactions 52. In particular, the semantic templates describe not only the fields that may be present to capture the data associated with an event, but also the inter-relationship between these fields and the rules or logic governing the content of the respective fields. The process may be iterated to update or improve the semantic templates(s) 56 until it is determined (block 58) that there are no additional transactions 52 to be processed or that the semantic template 56 would be unchanged by processing or reprocessing additional transactions 52. In addition, further iterations of the process might be triggered as new representative transactions 52 become available over time. As discussed herein, the semantic templates 56 may be created to accommodate a structured data format (such as might be created through automatic data input or drop down menus) or an unstructured data format expressed in free text fields, such as customer service requests.

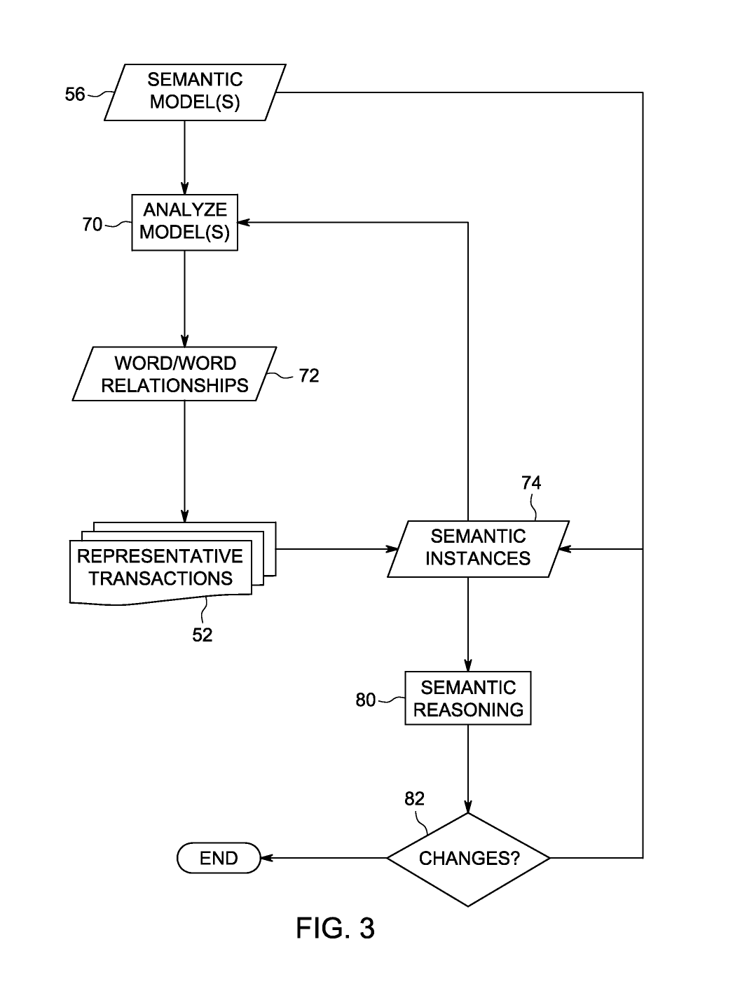

Turning to FIG. 3, once the semantic templates 56 have been constructed, a series of algorithms may be employed (block 70) to generate tables 72 of words and word relationships (n-tuples) from the semantic templates 56 that will be used as seeds for subsequent text-mining operations. As used herein, n-tuples may be composed of pairs or triplets of adjacent words in the semantic network or instances of words related by specific relationships described in the semantic templates. For example, the word “paint” followed or preceded by a color within three words of the word “paint” may constitute a specific relationship that might be captured as an n-tuple.

Initial instances 74 based on the semantic templates 56 may then be created. For example, fields containing one of a fixed number of entries can be mapped to the instances 74 by copying the contents from the original data (or from another comparable set of data) into the instances 74. In the depicted embodiment, free text fields in the data (e.g., transactions 52) are mapped using statistical text mining techniques that use the n-tuples extracted from the original semantic templates 56. In such an implementation, text mining techniques may structure the free text field within the transactions 52 for later semantic processing and may use information from the free text field to populate individual fields of the instance.

Next semantic reasoning (block 80) is applied to the instance 74 populated using statistical text mining algorithms. The semantic reasoning uses known rules or logic to evaluate the data fields filled in by text mining to identify incongruous data fields and validate remaining data fields. The semantic reasoning may also suggest contents for other data fields of the semantic instance 74 as constructed so far. Once semantic reasoning is done, a check may be performed to see if anything has changed (block 82) since the last semantic reasoning on the instance 74. If so, the process may be iterated by extracting (block 70) an updated set of n-tuples from the semantic instance 74. These new instances drive the biases that the statistical approach uses to generate the most likely matches, and the biases converge along with the instance 74 to drive the best solution. In one such implementation, the text mining techniques are driven by n-tuple structures created from the evolving instance 74, or in the case of the first iteration, from the original semantic template 56.

In certain implementations, text mining techniques may also be guided by semantic templates 56 and may allow some degree of structure to be imposed on or implied from a set of unstructured data (e.g. free text fields, and so forth). For example, word, word pairs, and/or n-tuple data structures 72 identified by analysis of a semantic template 56 may be used for text mining of data acquired in an unstructured form, such as to identify likely structured relationships within the data that can be leveraged in subsequent analysis. For example, n-tuple data structures for use in text mining may be taken or derived from patterns within the semantic structure. These data structures derived from the semantic template 56 (or from instance 74) and used for text mining may be simple listings of paired word relationships or may be more complex patterns that may represent semantic structures themselves. By way of example, for each field in an instance 74 generated based on a set of unstructured data, such as a free text field, a distribution of likely entries may be constructed, along with associated probabilities or rankings. The most likely entry exceeding a threshold likelihood may be entered into the respective field of the instance 74. In such an example, a confidence score or other likelihood indicator may be displayed in conjunction with a field entry determined in this manner.

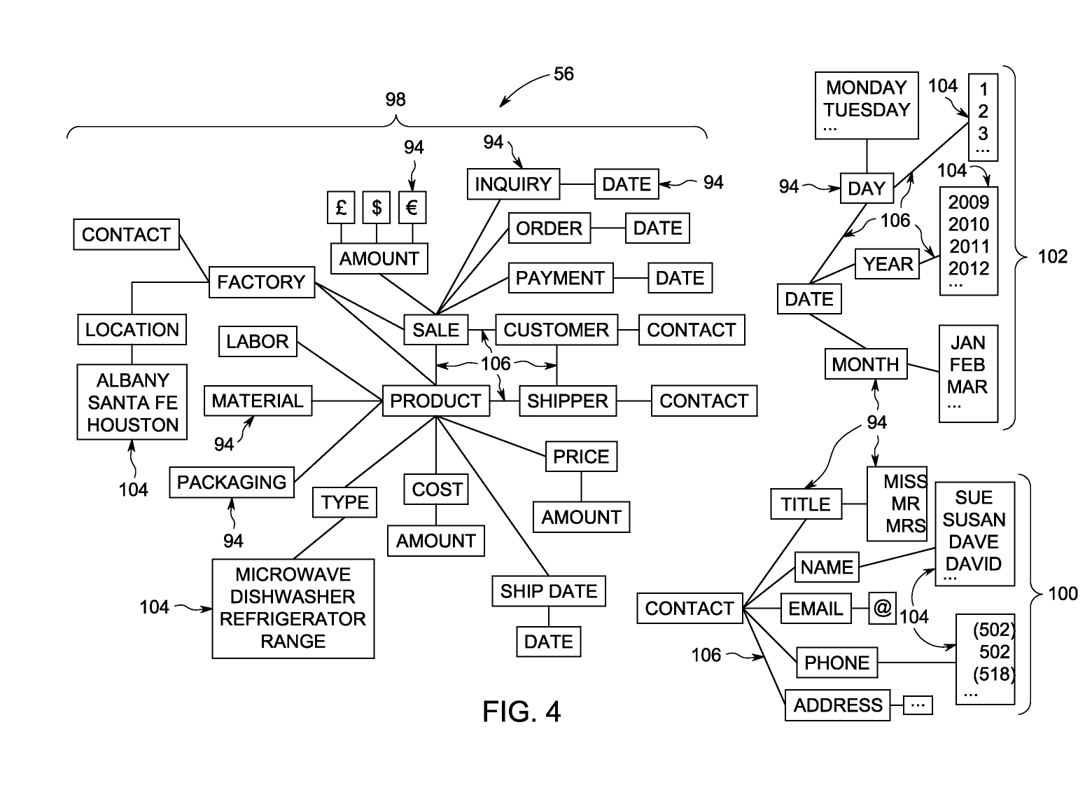

With the foregoing in mind, FIGS. 4-12 graphically depict the concepts discussed herein in conjunction with an example. For example, FIG. 4 depicts an example of a semantic template 56 comprising a multitude of related or interconnected fields 94 that encompass the various parameters that might be present for a given transaction. For convenience, each field 94 of FIG. 4 is labeled with a type of data to facilitate explanation. In the depicted example, fields 94 are depicted that relate to a “product” data structure 98, a “contact” data structure 100, and a “date” data structure 102, any one of which may have related data in any given sample transaction. That is, in this example, any given transaction would presumably have at least some data related to a product, a date, and/or a contact.

As depicted in FIG. 4, not only are the various fields 94 defined for a representative transaction, but also the relationships (i.e., the logical or semantic relationships) between respective fields 94, denoted by lines 106. For example, with respect to a “product” data structure 98, for any given product, there may be related data regarding a sale, a shipper or shipment, a ship date, a price, a cost, a type or model, a packaging, a material, and/or labor. Likewise, for each of these fields there may be additional data or fields defined in a structural or semantic relationship that provide additional detail. Similarly, in this example, the “contact” data structure 100 and “date” data structure 102 comprise fields that define additional data related to the respective structure and the respective relationships between such fields. As depicted in the present example, the data structures defined for the “contact” and “date” structures may in turn be referenced as fields in the “product” data structure. For example, a payment or order data point in the product data structure 98 may include a date field that may in turn be defined by the date data structure 102. In this manner, the semantic template 56 defines both the data fields 94 and the semantic or logical relationships between respective data fields 94 that may be present in a representative transaction.

In one implementation, one or more of the fields 94 may be characterized by the type or structure of data that may be entered, such as text strings, numeric strings, e-mail addresses, numbers strings formatted as or having characteristics of a data or phone number, and so forth. Such constraints may be useful in parsing or generating the n-tuples for text mining and/or for parsing data into the template 56 or assigning probabilities to unstructured data for which a structure is being derived.

In the depicted example, sample data 104, such as from representative transactions 52 may be associated with particular fields 94. For example, under the “type” field within the product data structure 98, various examples are listed (i.e., microwave, dishwasher, refrigerator, range) which may be derived from representative transactions that have been structures in accordance with the template 56. Similarly, other fields 94 are shown having representative data 104 (e.g., contact title, date day, date year, contact name, and so forth).

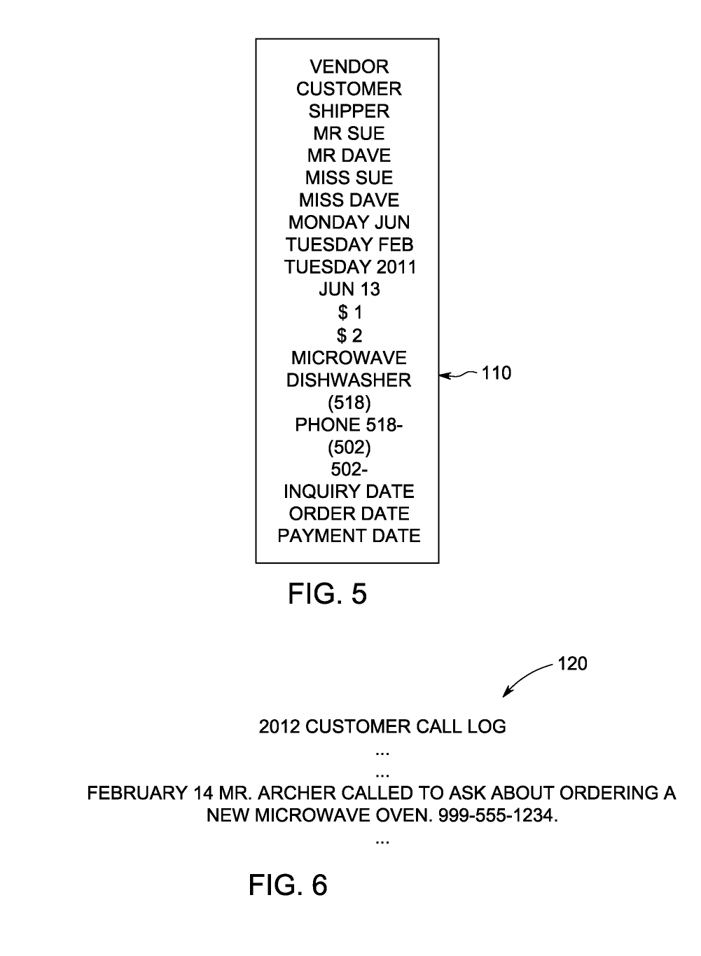

Such representative data 104 may be useful in generating n-tuples, as discussed herein. For example, turning to FIG. 5, an example is provided of n-tuples 110 (in the form of word, word pairs, word triplets, or other structured arrangements or sequences of data) that may be derived based on the defined semantic template 56 of FIG. 4 and from representative data or transactions 52 described by or categorized with respect to the template 56. For example, the n-tuples 110 used as examples in FIG. 5 may represent data 104 that has been observed in representative transaction as corresponding to one or more identified fields 94 within the semantic template 56 or which, based on structure or context, is believed to correspond to such fields. Thus, identified n-tuples 110, or data or data structures structurally similar to the identified n-tuples, may be used as seeds for text mining performed on new or historic data, such as to derive a structure for data that is acquired in an unstructured format, such as free-text field data.

With the foregoing in mind, FIG. 6 depicts a sample set of unstructured data. In particular, FIG. 6 depicts a hypothetical data record 120 for a 2012 customer call log. In this example, the data record reads: “February 14 Mr. Archer called to ask about ordering a new microwave oven. 502-345-7899.” In one implementation, an unstructured data record such as this may undergo text mining, such as using n-tuples 110 as seeds, to attempt to derive a structure for the data.

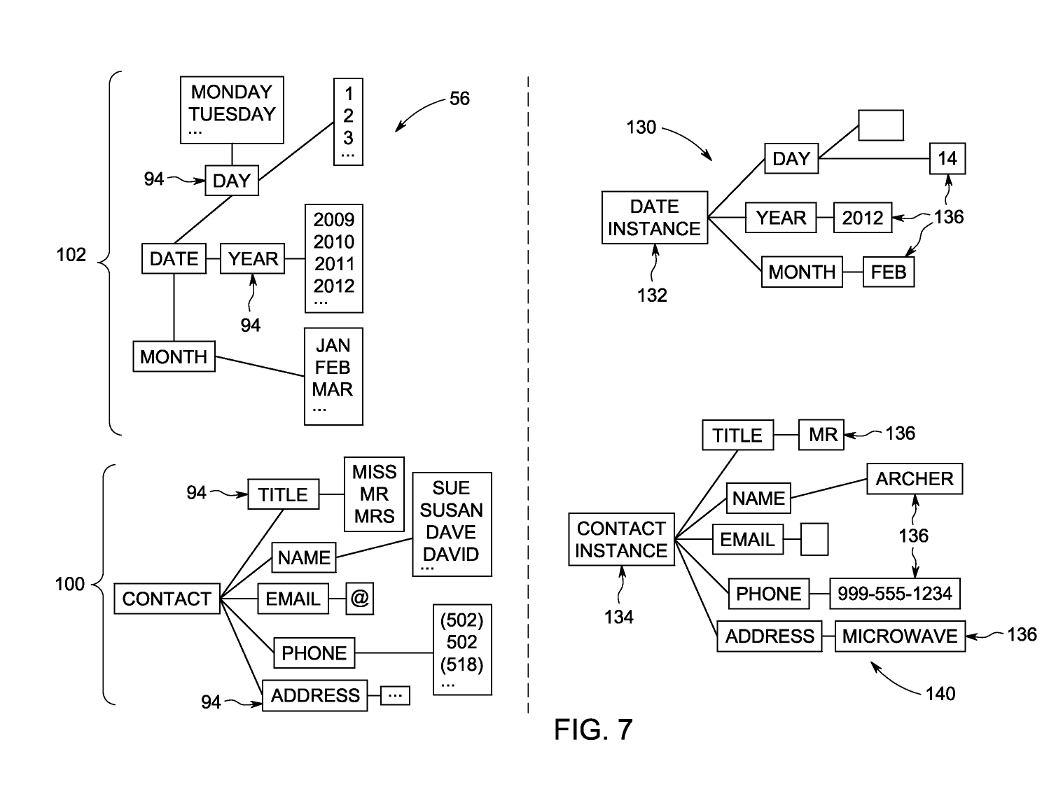

Turning to FIG. 7, an initial instance 130 is generated based on the unstructured data record 120, the semantic template 56 (particularly, the “date” data structure 102 and the “contact” data structure 10), and the results of an initial text mining operation based on the n-tuples 110. In the depicted example, the initial instance 130 data from the record 120 is parsed into fields 94 of the template 56 based on the assessed probabilities determined in the text mining operation. That is data is assigned to the most likely field 94 of the template 56 based on the statistical probabilities generated as part of the text mining operation.

In particular, the “date” data structure 102 and associated fields and the “contact” data structure 100 and associated fields are partially populated based on the call log record data to generate the example instance 130 which includes a data instance 132 and contact instance 134. Data derived from the call record 120 used to populate the instance 130 is shown as entered data 136. In the depicted example, an improperly assigned data element 140 is also shown in the instance 130. In particular, the data element “microwave” was incorrectly specified as a contact address based on the probabilities generated by the text mining operation.

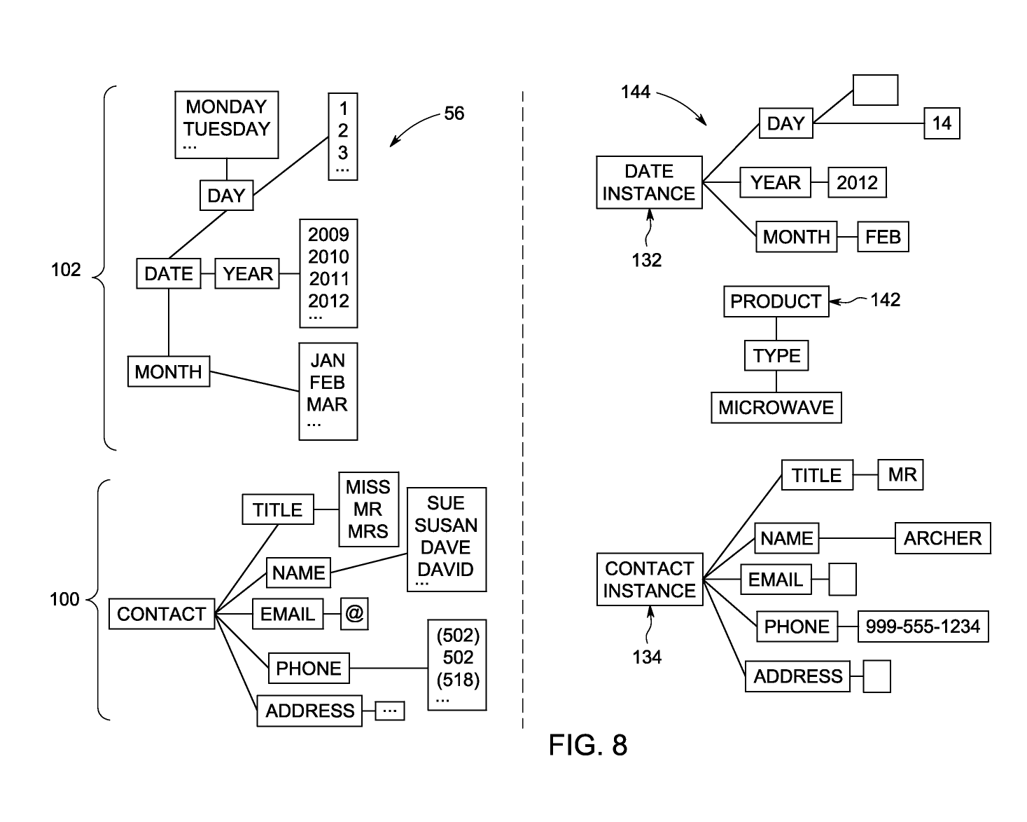

In certain embodiments, however, semantic rules derived based on the semantic template 56 may, subsequent to the text mining operation, evaluate the initial instance 130 to address such errors and to thereby generate an improved instance 144. In this example, turning to FIG. 8, based on semantic analysis, the data element “microwave” has been moved from the contact address field of the initial instance 130 to the “type” field of a product instance 142 of the initial instance. That is, in such an example, the probability derived based on the text mining operation may be discarded or ignored as the semantic rules specify that the term “microwave”, when encountered, is a product type.

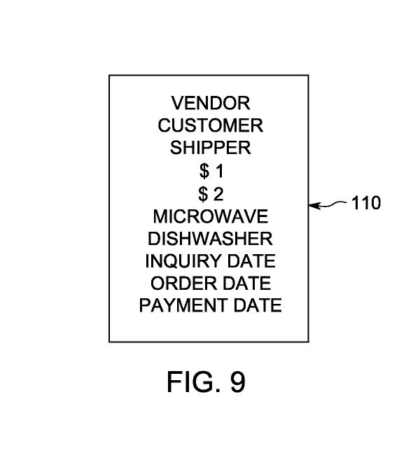

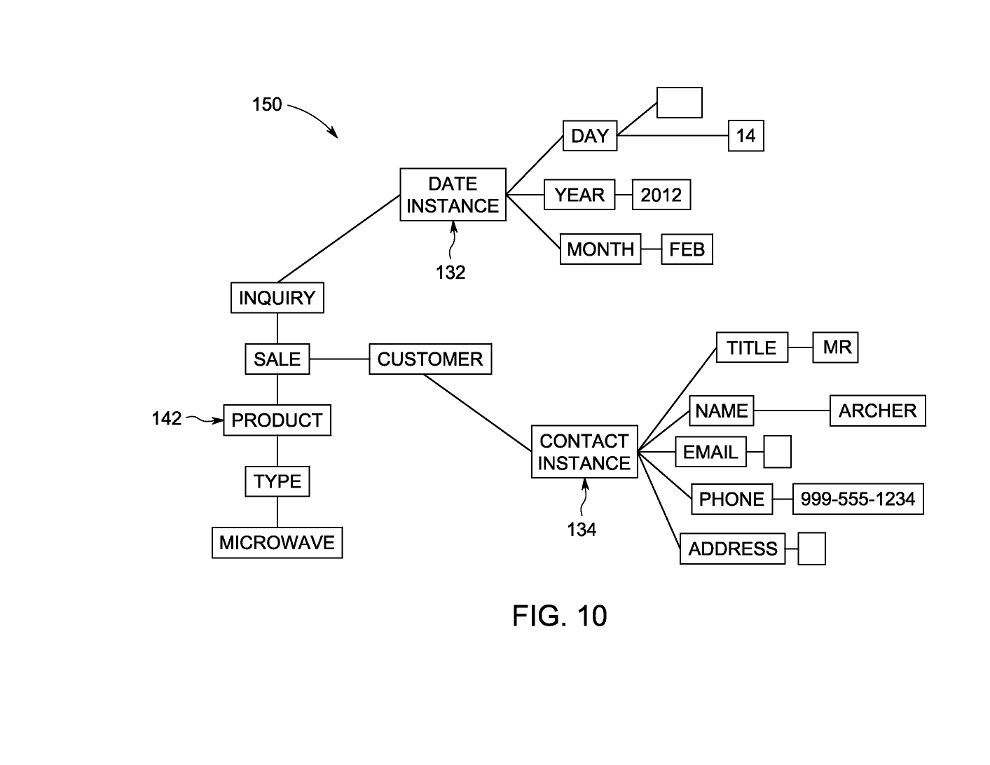

As will be appreciated, however, the relationship between the respective date instance 132, contact instance 134, and product instance 142 is still undefined. In this example, turning to FIG. 9, additional text mining seeds (e.g., an additional round of n-tuples 110) are generated that address the current degree or level or ambiguity or uncertainty with respect to the instance 144. Based on the new n-tuples, an additional round of text mining may be performed on the record being analyzed and the results of the text mining operation may be used to modify the current instance 144 (FIG. 10).

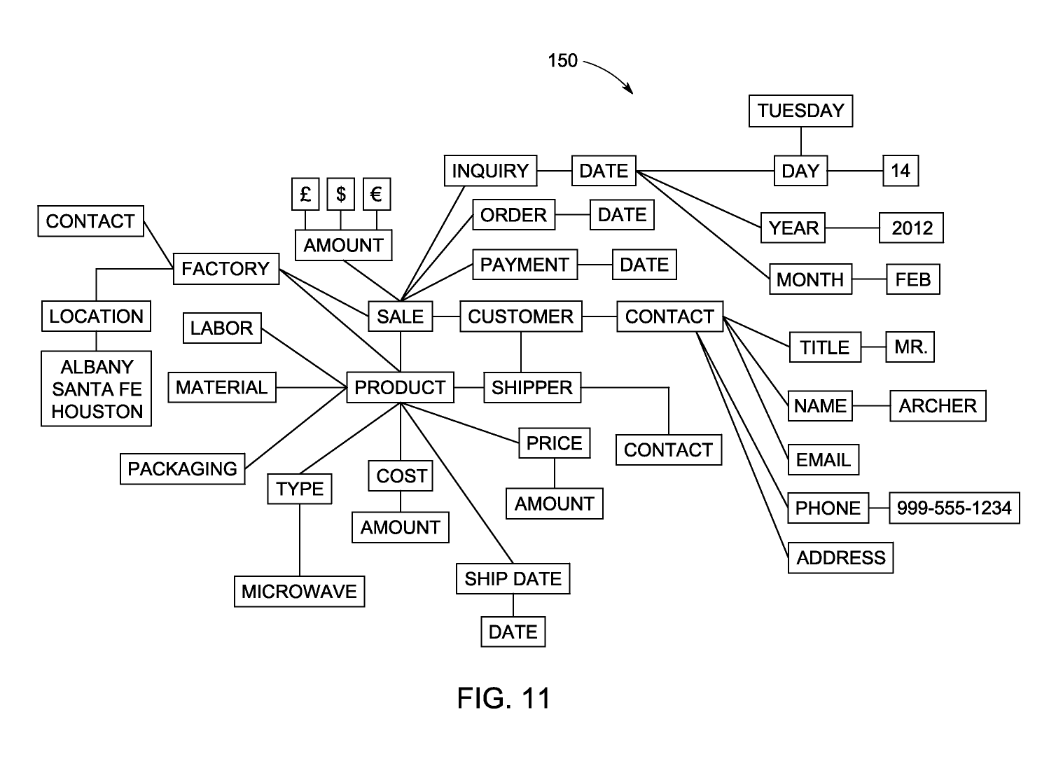

Based on the results of the additional round of text mining, and turning to FIG. 10, an instance 150 may be generated that links the sub-instances previously generated together. For example, the term “ask” in the call record being processed may be sufficient to probabilistically identify the record as relating to a product sale where the product was a microwave, the contact data related to a customer or potential customer, and the date data related to the date a sale inquiry was received. FIG. 11 depicts the current instance 150 within the larger context of the semantic template 56.

As will be appreciated from the preceding discussion and example, the present approach may be used to process and improve data sets which can be described by a semantic model. Typical of this class of data sets are business events (e.g., order to remittance), sales transactions, or inspection records. Further, processing of this event data in accordance with the present approaches would also include the content of free text fields to be normalized within the context of a larger semantic model. Additionally as discussed herein the present approach may be implemented as an iterative process, where the extent of the semantic instance grows with the information added by each iterative use of statistical text mining, and the power of the text mining extends through the quality of the n-tuple set and the reasoning biases extracted from the semantic instance.

Of note, the present approach allows data improvement using both semantic reasoning as well as statistical modeling. The hypotheses generated as a result of such a hybrid technique are better than those derived using either method alone. In particular, by combining semantic reasoning with statistical modeling, a level of certainty is captured and covers cases when few examples are available for training the statistical models. Conversely, by combining statistical modeling with semantic reasoning, the non-obvious relations can be identified by statistical models. The iterative application of both approaches allows for hypotheses to be created, validated, and retracted.

In practice, the present approach can be fully automated and embedded in other applications. The approach is data-agnostic, and through the use of text mining may process both fixed and free-text fields. Further, the present approach may be implemented in various manners, such as by embedding in batch programs or GUIs.

Technical effects of the invention include the use of both semantic and statistical models to improve the completeness and accuracy of data instances.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for processing data, comprising:
accessing a data record;
performing a text mining operation on the data record using seeds derived from a semantic template encompassing the data record;
populating one or more fields of a data instance using data elements derived from the analysis of the data record by the text mining operation, wherein the data instance is based on the semantic template;
updating the data instance based on semantic rules defined by the semantic template; and
updating the seeds and iterating the steps of: performing the text mining operation, populating one or more fields of the data instance, and updating the data instance based on semantic rules to generate a final data instance.

2. The computer-implemented method of claim 1, wherein the data record comprises a transaction record for a business or maintenance transaction.

3. The computer-implemented method of claim 1, wherein the seeds comprise n-tuples derived from the semantic template and a set of representative transactions.

4. The computer-implemented method of claim 1, wherein the one or more fields of the data instances are populated based upon probabilities generated by the text mining operation.

5. The computer-implemented method of claim 1, wherein the semantic template comprises:
a plurality of data fields associated with a generic transaction;
connections between the plurality of data fields; and
rules regarding potential content of the respective fields of the plurality of fields.

6. The computer-implemented method of claim 1, wherein the data record comprises an unstructured data record.

7. The computer-implemented method of claim 1, wherein the data record comprises a free text field.

8. A data processing system, comprising:
a memory storing one or more routines; and
a processing component configured to communicate with the controller and to execute the one or more routines stored in the memory, wherein the one or more routines, when executed by the processing component, cause acts to be performed comprising:
accessing a data record related to a transaction;
accessing a set of seeds derived from a semantic template that describes the transaction;
text mining the data record using the set of seeds;
populating one or more fields of a semantic instance using data elements identified in the data record by text mining, wherein the data instance is based on the semantic template and wherein the one or more fields are populated based upon probabilities generated by the text mining; and
analyzing the data instance based on one or more semantic rules associated with the semantic instance to validate the populated one or more fields of the semantic instance.

9. The data processing system of claim 8, wherein the one or more routines, when executed by the processing component, cause further acts to be performed comprising:
determining if additional processing of the data record is needed;
if additional processing is determined to be needed, deriving an additional set of seeds from the semantic template; performing a text mining based on the additional set of seeds, populating one or more additional fields of the semantic instance based on the results of the text mining operation; and reanalyzing the data instance based on the one or more semantic rules; and
if additional processing is determined to not be needed, ending the processing of the data record.

10. The data processing system of claim 8, wherein analyzing the data instance based on the one or more semantic rules comprises identifying data elements populating the wrong fields of the semantic instance.

11. The data processing system of claim 8, wherein analyzing the data instance based on the one or more semantic rules comprises suggesting content for fields of the semantic instance not populated by the text mining.

12. The data processing system of claim 8, wherein the semantic template is derived from a plurality of representative transactions.

13. The data processing system of claim 8, wherein the set of seeds comprise n-tuples derived from the semantic template and a plurality of representative transactions.

14. The data processing system of claim 8, wherein the semantic template comprises:
a plurality of data fields associated with a generic transaction;
inter-relationships between the plurality of data fields; and
rules regarding potential content of the respective fields of the plurality of fields.

15. The data processing system of claim 8, wherein the data record comprises an unstructured data record.

16. One or more non-transitory computer-readable media encoding one or more processor-executable routines, wherein the one or more routines, when executed by a processor, cause acts to be performed comprising:
accessing a data record related to a transaction;
accessing a semantic template derived from a plurality of representative transactions that described the transaction; and
generating a data instance corresponding to the data record by iteratively:
performing statistical text mining of the data record using seeds derived from the semantic template; and
analyzing the data instance using one or more semantic rules derived from the semantic template.

17. The one or more non-transitory computer-readable media of claim 16, wherein the semantic template comprises:
a plurality of data fields associated with a generic transaction;
connections between the plurality of data fields; and
rules regarding potential content of the respective fields of the plurality of fields.

18. The one or more non-transitory computer-readable media of claim 16, wherein the data record comprises an unstructured data record.

19. The one or more non-transitory computer-readable media of claim 16, wherein the data record comprises a free text field.

20. The one or more non-transitory computer-readable media of claim 16, wherein analyzing the data using the one or more semantic rules comprises one or both of:
identifying data elements populating the wrong fields of the semantic instance;
suggesting content for fields of the semantic instance not populated by the text mining.
